(19) United States
(12) Patent Application Publication
(10) Pub. No.: US 2015/0326544 A1
(43) Pub. Date: Nov. 12, 2015

(54) METHOD OF PROCESSING DATA IN DISTRIBUTED STORAGE SYSTEM

(71) Applicant: ORANGE, Paris (FR)

(72) Inventors: Phillipe Raipin Parvedy, Saint Ouen Des Alleux (FR); Pierre Obame Meye, Rennes (FR)

(21) Appl. No.: 14/652,109

(22) PCT Filed: Dec. 4, 2013
(86) PCT No.: PCT/FR2013/052943

§ 371 Date: Jun. 13, 2015

(30) Foreign Application Priority Data
Dec. 18, 2012 (FR) 1262219

(51) Int. Cl. H04L 29/06; H04L 9/32

(52) U.S. Cl. CPC H04L 63/0442; H04L 9/3247; H04L 63/061

(57) ABSTRACT

The invention relates to a method of processing data in a system including a first device (PC) able to require a second device to perform an operation on a datum, the first device storing both a private key and a public key, the second device being able to store at least one encrypted datum (A′) using the public key, characterized in that it includes:
a step (ET12) in which an operation (ADD:B) to be performed is encrypted in the first device, in connection with said at least one datum (A),
a first step (ET13) in which the result of the encryption ((ADD:B)′) is sent to the second device,
a first step (ET14) in which said result is received by and stored in the second device,
   following a request to access the data from the first device,
a second step (ET22) in which the set of stored data (A′, (ADD:B)′) is sent from the second device,
a second reception step (ET25) by the first device followed by a decrypting step using the private key and an operation performance step (A ADD B).

### TECHNICAL DOMAIN

The invention relates to a method of processing data in an IT system.

The system includes a first device able to require a second device to store a datum and an operation to be performed on said datum.

In this system, the first device stores both a private key and a public key, and the second device is able to store an encrypted datum using the public key.

The processing in question is such that the stored data resulting from the processing is homomorphic. Homomorphic storage has the following features: a datum stored on a device can only be read by authorized users (U) with access permissions over the datum. Other third-party users (T) can apply the processing to this datum without having access to the content of same. The results of the processing can only be read by authorized users (U).

This type of storage enables the first device to process data remotely on a second device without the data being disclosed/accessible on the second device.

The processing may be of any type, such as video transcoding, salary analysis, etc.

### PRIOR ART

The telecommunications sector is currently undergoing a change from an operating mode in which end users store their own information and applications, to another operating mode in which the information will be stored remotely/distributed to remote devices. This other operating mode is currently called “cloud computing” in English, and is well known to the person skilled in the art.

In such a system, in which data is processed remotely, the confidentiality of the data is the security factor most affected. Indeed, it is not really known where the data is stored and processed. Furthermore, it is not known how the data is processed, even if the supplier claims to guarantee confidentiality. Users cannot be sure that their data will not be decrypted during processing and therefore disclosed.

In other words, agreeing to store data on the network involves a certain loss of control over the life cycle of the data.

The invention is intended to improve the situation.

### THE INVENTION

For this purpose, according to a functional aspect, the invention relates to a method of processing data in a system including a first device able to require a second device to perform an operation on a datum, the first device storing both a private key and a public key, the second device being able to store at least one encrypted datum (A′) using the public key, characterized in that it includes:
a step in which an operation to be performed is encrypted in the first device, in connection with said at least one datum (A),
a first step in which the result of the encryption is sent to the second device,
a first step in which said result is received by and stored in the second device,

following a request to access the data from the first device,
a second step in which the set of stored data is sent from the second device,
a second reception step by the first device followed by a decrypting step using the private key and an operation performance step.

The processes to be carried out are therefore stored encrypted in the second device. In other words, the second device does not perform the processing, but merely commits the process to be performed to memory. The first device then requires access to the data stored on the second device, the first device gets back the data and the process to be performed, and it is only then that the process is applied to the data.

Consequently, according to the invention, the data and the processes are not decrypted on the second device. Without knowing the private key used for encryption, it is therefore almost impossible to access the data on the second device.

The principle of homomorphic storage defined above is therefore respected.

According to a first specific embodiment of the invention, the operation performance step is followed by a step in which the public key is used to encrypt the result of the operation performance step, and the result of this encryption is sent to the second device (SRV) to be stored therein. This feature means that, if the first device later accesses again the data stored on the second device, the first device is not required to repeat the operation previously carried out. The savings in terms of physical and/or software resources is even greater if the operation to be carried out is complicated.

According to another specific embodiment of the invention, which may be implemented as an alternative or in addition to the preceding embodiment, the first device has an indexing table in which an index corresponds to a respective operation and, in the encryption step, in the first device, the operation to be encrypted includes the index corresponding to the operation to be performed. Thus, even if the data have been disclosed in the second device, ignorance of the operation to be performed prevents disclosure of the result of the operation.

According to another specific embodiment of the invention, which may be implemented as an alternative or in addition to the preceding embodiments, the encryption step includes a digital signature generated by the first device. According to another specific embodiment of the invention, which may be implemented as an alternative or in addition to the preceding embodiment, the encryption step includes a random number generated by the first device. The latter two embodiments guarantee that the data received from the second device initially came from the first device.

According to a material aspect, the invention relates to a computer program that can be implemented on a device, said program including code instructions for implementing the method according to one of the preceding claims, if this program is run by a processor.

Such a program can use any programming language. It may be downloaded from a communication network and/or saved on a computer-readable medium.

According to another material aspect, the invention relates to a device, referred to as the second device in the example embodiment below, including a storage module that can store at least one encrypted datum (A′) using a public key, characterized in that it includes:
a module for receiving at least one encrypted operation to be carried out in combination with said at least one datum (A), the operation being encrypted using the public key,
a storage module able to store said at least one encrypted operation,
a transmission module able to send, on demand, said at least one encrypted datum (A′) and said at least one encrypted operation.

According to another material aspect, the invention relates to a device, referred to as the first device in the example embodiment below, including a storage module that can store a private key and a public key, characterized in that it includes:
an encryption module able to encrypt at least one operation to be carried out in combination with at least one datum stored on another device,
a module for sending said at least one encrypted operation,
An access-request module able to require access, on said other device, to the data sent,
A module for receiving at least one encrypted datum and at least one encrypted operation,
a decryption module able to decrypt, using the private key, said at least one encrypted datum and said at least one encrypted operation,
a processing module for carrying out the operation.

With reference to the first embodiment described above, the encryption module is able to encrypt, using the public key, the result of the operation (A ADD B), and the transmission module is able to send the result of this encryption to the second device (SRV) to be stored there.

The invention also relates to the IT system including the first device and the second device mentioned above.

The invention can be better understood from the description below, given by way of example and with reference to the attached drawings, in which:

### FIGURES

FIG. 1 shows an IT system in which an example embodiment of the invention is illustrated.

FIG. 2 shows the data exchanges between a first and a second device with reference to an example embodiment.

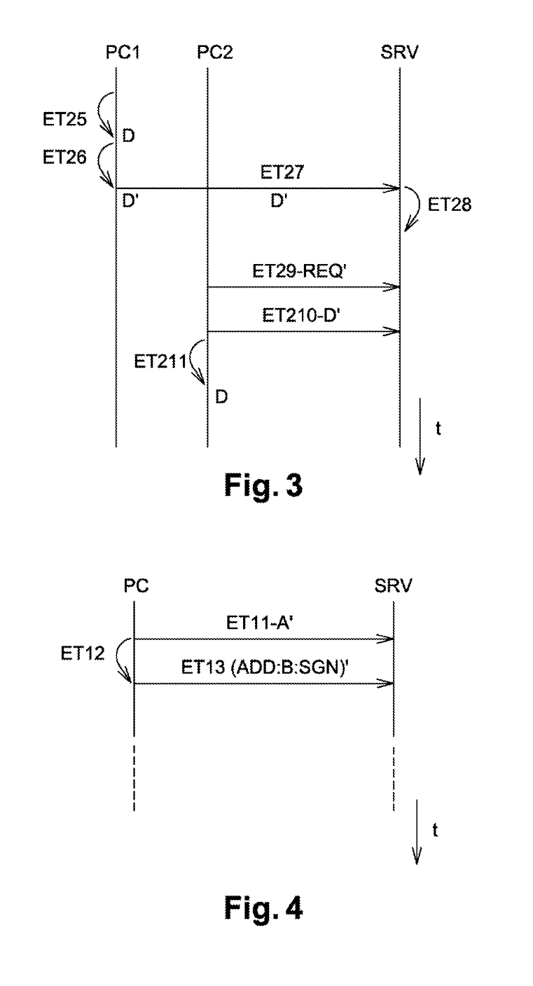

FIGS. 3 to 7 are variants of the example embodiment described with reference to FIG. 2.

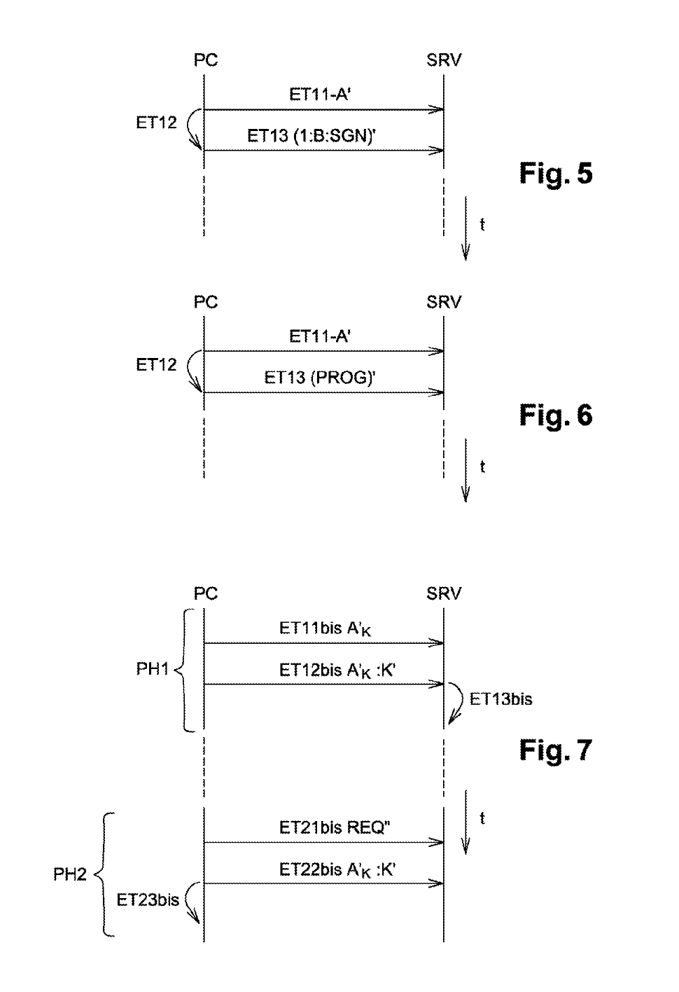

### DETAILED DESCRIPTION OF AN EXAMPLE EMBODIMENT ILLUSTRATING THE INVENTION

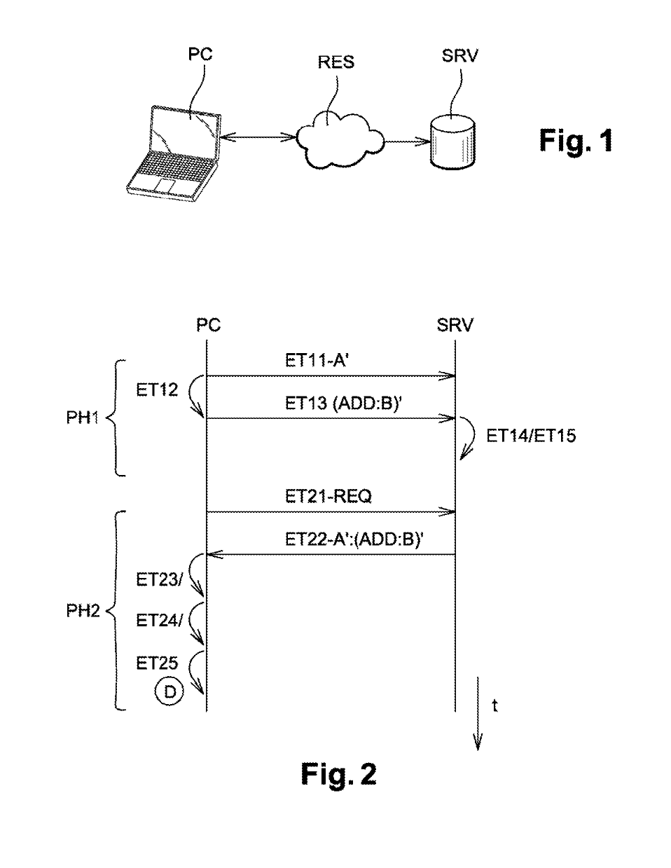

FIG. 1 shows a system SYS illustrating an embodiment.

An example embodiment is described below with reference to FIG. 1. In this example, two groups of users are considered:
a first user group G1, users with read/write permissions over the data,
a second user group G2, users authorized to perform operations, but who do not have read permissions over the data.

The first group G1 has access to a pair of keys, i.e. a public key and a private key.

The second group only has access to the public key. As such, if the second group receives a datum encrypted using the public key, it cannot decrypt said datum without knowing the secret key.

Henceforth, the result of encryption of a datum DATA shall be notated DATA′.

A datum may also be processed, for example by means of addition ADD, multiplication MUL, etc.

Henceforth, a process, for example addition, performed on a datum DATA, shall be notated ADD:DATA.

Henceforth, in order to simplify the description of an embodiment, the first group G1 shall be illustrated using a device PC and the second group using a device such as a processing server SRV.

Henceforth, a datum A shall be sent by the first device to the server SRV.

The method comprises two phases:
a first storage and processing phase PH1,
and a second phase PH2 for accessing the data stored on the server SRV.

During the first phase PH1, in the present example, the datum A is stored and encrypted using the public key of same in the device PC.

The first phase includes several steps referenced ET1n (n=1 to 5).

During the first step ET11, the encrypted datum A′ is sent from the device PC to the server SRV to be stored therein.

A specific process is then applied to the datum A. In the present example, B is added to A.

In a second step ET12, the device PC encrypts the operation ADD and the datum B. The result is notated (ADD:B)′.

During a third step ET13, the device PC sends the result of the encryption of the second step ET12.

During a fourth step ET14, the server receives the result of the encryption of the second step, i.e. (ADD:B)′.

Upon receipt, the server memorizes the order of arrival of the different data from the device PC. This order is then communicated to the device PC when the data are accessed to ensure that the decryption operation observes this order.

In the present example, during a fifth phase ET15, the server adds (ADD:B)′ to the datum A′.

The result is notated:

A′:(ADD:B)′

In the present example, a user from the first group then wishes to access the data stored on the server. The second phase 2 in which the data stored on the server are accessed includes several steps referenced ET2k (k=1 to 5).

During a first step ET21, an access request REQ is sent from the device PC to the server SRV.

During a second step ET22, the server responds by sending the result of the fifth step ET15 of the first phase, i.e.

A′:(ADD:B)′

During a third step ET23, the device receives A′:(ADD:B)′ and decrypts with the private key.

During a fourth step ET24, the device obtains the data and the operation to be applied to the data, i.e. A ADD B.

During a fifth step ET25, the device obtains the result of the sum of A and B. The result is notated D.

The embodiment described above can obviously be subject to variations, including the following.

In the example described above, a single device communicates with the server. However, any number of devices and servers may be used. In the present example, two devices communicate with the server: a first device PC1 and a second device PC2. According to a first variant of the embodiment described above, after the fifth step ET25, during a sixth step ET26, the result D is encrypted with the public key and sent during a seventh step ET27 from the device, referred to as the first device, to the server to be stored therein during an eighth step ET28.

A request REQ′, sent for example by the second device PC2 during a ninth step ET29, to again access the data stored on the server shall be followed by transmission from the server of the encrypted datum D′ during a tenth step ET210. If this request originates from the second device, this second device receives the encrypted datum D′. This second device then need only decrypt D′ with the private key to obtain D during an eleventh step ET211.

This variant obviates the need to repeat an operation already carried out by the device.

According to a second variant, described with reference to FIG. 4, each processing request issued by a device includes a digital signature in order to guarantee, as with all digital signatures, the integrity of the processing request and to authenticate the device from which the request originated.

In the present example, during a second step ET12, the device PC encrypts the operation ADD, the datum B and the signature SGN. The result is notated (ADD:B:SGN)′.

During the third step ET13, the device PC sends the result of the encryption (ADD:B:SGN)′.

According to a third variant, described with reference to FIG. 5, the different types of operation are indexed, for example as follows:

ADD=1, MUL=2, SIN=12, etc.

The device PC stores this indexing, for example in the form of a look-up table.

Subsequently, during the second step ET12, the device PC encrypts the operation ADD and the datum B, and potentially the digital signature if the third variant is used. The result is notated (ADD:B:SGN)′. The device transforms this result into (1:B:SGN)′.

During a third step ET13, the device PC sends (1:B:SGN) to the server SRV.

During the third step ET23 of the second phase, the device receives A′:(1:B:SGN)′, which it decrypts with the private key.

In this variant, the server does not have access to the operation used ADD. This third variant reduces the risk of disclosure of the data belonging to G1.

According to a fourth variant, described with reference to FIG. 6, instead of a simple indexed operation (ADD, MUL, SIN, etc.), an operation can be a complete program able to process data. If the datum is A, in this case, all of the binary code of the program is encrypted, sent and added to the datum A′ on the server SRV.

In this case:
During the third step ET13 of the first phase, the device PC sends (PROG)′ to the server SRV.
During the fourth step ET14 of the first phase, the server receives (PROG)′ and adds same to A′. The result is notated A′:(PROG)′.

A fifth variant, described with reference to FIG. 7, enables the risk of disclosure to be further reduced.

According to this fifth variant, instead of encrypting everything using asymmetrical keys, a symmetrical key is used to encrypt the datum, and the symmetrical key is encrypted with the public key of the datum.

During a first step ET11bis, the datum A is encrypted using the symmetrical key K. The result, notated A′_{K}, is stored in the server SRV.

During this first step, the symmetrical key is encrypted using the public key. The result is notated K′.

During a second step ET12bis, the device PC sends both results A′_{K}:K′

During a third step ET13bis, the server receives A′_{K}:K′ and memorizes same.

In the present example, a user from the first group then wishes to access the datum A stored on the server.

The second phase is carried out as follows:

During a first step ET21bis, an access request REQ″ is sent from the device PC to the server SRV.

During a second step ET22bis, the server responds by sending A′_{K}:K′

During a third step ET23bis, the device receives A″_{K}:K′ and decrypts K′ with the private key. It first obtains K, and decrypts A^{′}_{K} with the symmetrical key in order to obtain A.

According to a sixth and final variant, similar to the second variant, each processing request coming from a device includes a random number generated by the device.

In the present example, during a second step ET12, the device PC encrypts the operation ADD, the datum B and a random number ALEA. The result is notated (ADD:B:ALEA)′.

During the third step ET13, the device PC sends the result of the encryption (ADD:B:ALEA)′.

To carry out the method described above, the server SRV includes:
a module for receiving at least one encrypted operation (ADD:B)′ to be carried out in combination with said at least one datum A, the operation being encrypted using the public key,
a storage module able to store said at least one encrypted operation (ADD:B)′,
a transmission module able to send, on demand, said at least one encrypted datum (A′) and said at least one encrypted operation (ADD:B)′.
   Furthermore, to carry out the method described above, the device PC includes:
an encryption module able to encrypt at least one operation (ADD:B) to be carried out in combination with at least one datum A stored on another device,
a module for sending said at least one encrypted operation (ADD:B)′,
An access-request module able to require access, on said other device, to the data sent,
A module for receiving at least one encrypted datum and at least one encrypted operation,
a decryption module able to decrypt, using the private key, said at least one encrypted datum and said at least one encrypted operation,
a processing module for carrying out the operation (A ADD B).

It should be noted that the term “module” used in this document may refer either to a software component or to a hardware component, or even to a set of hardware and/or software components able to implement the function or functions described for the module.

The expression “at least one encrypted operation” may mean either an encryption of a plurality of operations or a plurality of operation encryptions respectively. Equally, “at least one encrypted datum” may mean either an encryption of a plurality of data or a plurality of data encryptions respectively.

In the example given above, a single operation (ADD:B) is described. Naturally, one process may include a plurality of operations.

In the present example, the following operations are to be applied to the datum A:

ADD:B and MIN:C

Moreover, these two operations are sent at two different instants t1 and t2, and the first device does not require access to the data stored on the server between these two instants.

In this configuration, the first operation is sent encrypted at a first instant (ADD:B)′.

The server stores A′:(ADD:B)′.

At this stage, the server is storing two encrypted data A′ and (ADD:B)′.

The second operation is sent in encrypted form (MIN:C)′.

The server stores A′:(ADD:B)′:(MIN:C)′.

The server retains the order of the data and operations that it receives from the terminal. Thus, when the terminal requires access to the data, the server sends the set of encrypted data, in this case the encrypted datum A′, and the encrypted operations: (ADD:B)′ and (MIN:C)′, observing the order of receipt.

The terminal can then, upon receipt, decrypt the set of encrypted blocks, i.e. A′, (ADD:B)′ and (MIN:C) using the private key, to obtain:

(A ADD B) MIN C

observing the related order.

In the example embodiment described above, the server memorizes the order of arrival of the different data coming from the device PC. This order is then communicated to the device PC when the data are accessed to ensure that the decryption operation observes this order.

Retaining the order of arrival may involve concatenating the blocks of encrypted data received one after the other. In this example, n blocks B1 . . . Bn are received successively one after the other by the server. In order to retain the order of arrival of the blocks, the server concatenates the blocks B1:B2: . . . :Bn.

When the terminal needs to access the data, the server responds by sending the concatenated blocks B1:B2: . . . :Bn.

1. A method of processing data in a system including a first device able to require a second device to perform an operation on a datum, the first device storing both a private key and a public key, the second device being able to store at least one encrypted datum (A′) using the public key, characterized in that it includes:
a step (ET12) in which an operation (ADD:B) to be performed is encrypted in the first device, in connection with said at least one datum (A),
a first step (ET13) in which the result of the encryption ((ADD:B)′) is sent to the second device,
a first step (ET14) in which said result is received by and stored in the second device,
following a request to access the data from the first device,
a second step (ET22) in which the set of stored data (A′, (ADD:B)′) is sent from the second device,
a second reception step (ET25) by the first device followed by a decrypting step using the private key and an operation performance step (A ADD B).

2. The method as claimed in claim 1, characterized in that the operation performance step (A ADD B) is followed by a step in which the public key is used to encrypt the result of the operation performance step, before same is sent to the second device (SRV) to be stored therein.

3. The method as claimed in claim 1, characterized in that the first device includes an indexing table (1->ADD, 2->MUL) in which an index corresponds to a respective operation, and in that, during the encryption step, in the first device, the operation to be encrypted (1:B) includes the index corresponding to the operation to be carried out.

4. The method as claimed in claim 1, characterized in that the encryption step includes a digital signature generated by the first device.

5. The method as claimed in claim 1, characterized in that the encryption step includes a random number generated by the first device.

6. A computer program that can be implemented on a device, said program including code instructions for implementing the method according to claim 1, if this program is run by a processor.

7. A device (SRV) including a storage module able to store at least one encrypted datum (A′) using a public key, characterized in that it includes:
a module for receiving at least one encrypted operation ((ADD:B)′) to be carried out in combination with said at least one datum (A), the operation being encrypted using the public key,
a storage module able to store said at least one encrypted operation ((ADD:B)′),
a transmission module able to send, on demand, said at least one encrypted datum (A′) and said at least one encrypted operation ((ADD:B)′).

8. A device (PC) including a storage module able to store a private key and a public key, characterized in that it includes:
an encryption module able to encrypt at least one operation (ADD:B) to be carried out in combination with at least one datum (A) stored on another device,
a module for sending said at least one encrypted operation ((ADD:B)′),
an access-request module able to require access, on said other device, to the data sent,
a module for receiving at least one encrypted datum and at least one encrypted operation,
a decryption module able to decrypt, using the private key, said at least one encrypted datum and said at least one encrypted operation,
a processing module for carrying out the operation (A ADD B).

9. The device as claimed in claim 8, characterized in that the encryption module is able to encrypt, using the public key, the result of the operation (A ADD B), and in that the transmission module is able to send the result of this encryption to the second device (SRV) to be stored therein.

10. An IT system including a first device (PC) including a storage module able to store a private key and a public key, characterized in that it includes:
an encryption module able to encrypt at least one operation (ADD:B) to be carried out in combination with at least one datum (A) stored on another device,
a module for sending said at least one encrypted operation ((ADD:B)′),
an access-request module able to require access, on said other device, to the data sent,
a module for receiving at least one encrypted datum and at least one encrypted operation,
a decryption module able to decrypt, using the private key, said at least one encrypted datum and said at least one encrypted operation,
a processing module for carrying out the operation (A ADD B); and
a second device (SRV) including a storage module able to store at least one encrypted datum (A′) using a public key, characterized in that it includes:
a module for receiving at least one encrypted operation ((ADD:B)′) to be carried out in combination with said at least one datum (A), the operation being encrypted using the public key,
a storage module able to store said at least one encrypted operation ((ADD:B)′),
a transmission module able to send, on demand, said at least one encrypted datum (A′) and said at least one encrypted operation ((ADD:B)′).
